(19) United States
(12) Patent Application Publication
(10) Pub. No.: US 2014/0366875 A1
(43) Pub. Date: Dec. 18, 2014

(54) SYSTEMS AND METHODS FOR PROVIDING AIRCRAFT PASSENGERS WITH OXYGEN

(71) Applicant: Kourosh Merrikhi Motlagh, Lakewood, CO (US)

(72) Inventor: Kourosh Merrikhi Motlagh, Lakewood, CO (US)

(21) Appl. No.: 14/304,764

(22) Filed: Jun. 13, 2014

Related U.S. Application Data
(60) Provisional application No. 61/834,769, filed on Jun. 13, 2013.

(51) Int. Cl. A62B 7/08; A62B 9/00; A62B 9/02; A62B 7/14; A62B 7/02

(52) U.S. Cl. CPC A62B 7/08; A62B 7/14; A62B 7/02; A62B 9/022; A62B 9/006
USPC 128/202.26

(57) ABSTRACT

The disclosure provides apparatus and methods of use pertaining to providing concentrated oxygen to an oxygen-dependent airline passenger. One embodiment provides an on-board oxygen concentrator that includes at least one air compressor secured in a compartment of an aircraft and at least one zeolite sieve bed also secured in a compartment of the aircraft, such as the same compartment. The zeolite sieve beds are operatively connected to the compressor to receive compressed aircraft cabin air from the compressor and emit concentrated oxygen. A pressure regulator controls pressure of oxygen emitted to a passenger of the aircraft. Other embodiments are also disclosed.

### REFERENCE TO PENDING PRIOR PATENT APPLICATION

This application claims the benefit under 35 U.S.C. 119(e) of U.S. Provisional Patent Application No. 61/834,769, filed Jun. 13, 2013 by Kourosh Merrikhi Motlagh for “SYSTEMS AND METHODS FOR PROVIDING AIRCRAFT PASSENGERS WITH OXYGEN” which patent application is hereby incorporated herein by reference.

### BACKGROUND

Generally, during all hours of the day, many elderly and other patients with respiratory diseases or other issues are dependent upon oxygen and require continuous use of oxygen devices, such as compressed oxygen cylinders, liquid oxygen cylinders, and/or oxygen concentrators or generators. Unfortunately, these patients cannot travel with ease because of their oxygen dependency, especially during air travel.

A number of downfalls exist with the systems currently available to oxygen-dependent patients/passengers seeking air travel. For instance, due to their highly flammable and explosive nature, oxygen tanks and cylinders are categorically prohibited on flights. The only other option for oxygen-dependent passengers is to carry a portable oxygen concentrator. Not all portable oxygen concentrators are approved by the Federal Aviation Administration (FAA), and FAA approved devices can be extremely expensive. Even if an FAA approved portable oxygen concentrator is feasible for a particular oxygen-dependent passenger, such devices may only be allowed on certain airlines and/or for flights to limited destinations. That is, not all airlines allow portable oxygen concentrators on board, and when they do, oxygen concentrators are only offered to limited approved destinations on certain airlines.

In addition, insurance companies typically do not cover expensive FAA approved oxygen concentrators, and finding FAA approved oxygen concentrators and renting them for the purpose of air travel is problematic. This is because Durable Medical Equipment (DME) companies typically will not invest in such expensive devices due to the short rental period (e.g., only lasting the duration of a flight), which corresponds to low profit margins.

As a result of the aforementioned complications, many physicians do not recommend that their oxygen-dependent patients travel by air. Even those patients who do manage to gain access to FAA approved oxygen concentrators (i.e., rented or purchased) are provided with multiple heavy batteries depending on the duration of their flights. Issues with battery functionality and the problem of charging batteries with portable oxygen concentrators can be stressful. Regardless, transporting a heavy portable oxygen concentrator along with accompanying batteries is troublesome and/or difficult or impossible for patients with the type compromised health issues that lead to oxygen dependency.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

One embodiment provides an oxygen concentrator or generator that includes at least one air compressor secured in a compartment of an aircraft. At least one zeolite sieve bed is also secured in a compartment of the aircraft, and in certain embodiments, in the same compartment. This compartment may be in a bulkhead of the aircraft, a seatback of the aircraft, or similarly situated, such as for easy access by a seated passenger. The zeolite sieve bed(s) is/are operatively connected to the compressor(s) to receive compressed aircraft cabin air from the compressor and emit concentrated oxygen. A pressure regulator controls pressure of oxygen emitted to a passenger of the aircraft.

Another embodiment provides a method of providing oxygen to an oxygen-dependent aircraft passenger using an oxygen reservation and tracking tool having a processing engine that is operatively coupled to a database and a graphical user interface. The method includes receiving, via the graphical user interface, passenger information and storing, by the database, the passenger information. The method also includes generating, by the processing engine, reservation information relating to one or more oxygen suppliers for use during a segmented journey involving a flight on an aircraft, checking out, via the graphical user interface, a first of the oxygen suppliers for a first segment of the journey, and checking out, via the graphical user interface, a second of the oxygen suppliers for a second segment of the journey.

Yet another embodiment provides a method of administering oxygen to an oxygen-dependent aircraft passenger. The method includes administering oxygen, using a first oxygen supplier, over a first segment of a journey involving a flight on an aircraft, exchanging the first oxygen supplier for a second oxygen supplier, administering oxygen, using the second oxygen supplier, over a second segment of the journey involving the flight, exchanging the second oxygen supplier for a third oxygen supplier, and administering oxygen, using the third oxygen supplier, over a third segment of the journey involving the flight.

Other embodiments are also disclosed.

Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1 provides an environmental view of one embodiment of an oxygen concentrator that is integrated into a bulkhead of a commercial airliner;

FIG. 2 shows tubing associated with the oxygen concentrator of FIG. 1;

FIG. 3 provides a functional diagram of the exemplary oxygen concentrator of FIG. 1;

FIG. 4 provides a schematic of one embodiment of an oxygen reservation and tracking system;

FIG. 5 provides a flow chart illustrating an exemplary operation process of the oxygen and tracking system of FIG. 4; and

FIG. 6 provides a flow chart illustrating another exemplary operation process of the oxygen and tracking system of FIG. 4.

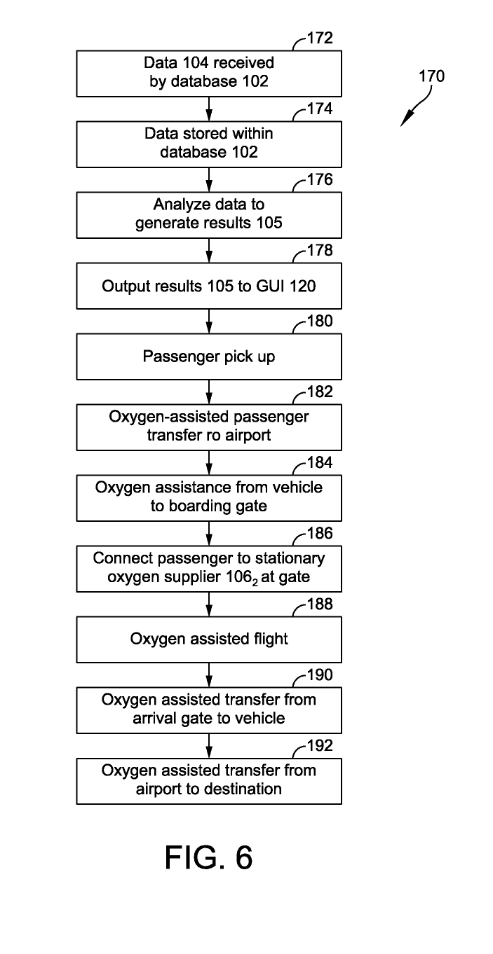

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

Various embodiments of the systems and methods described herein relate to equipping aircraft passengers with oxygen concentrators or generators. Some embodiments include a small oxygen concentrator integrated into a passenger aircraft for use by oxygen-dependent patients. This oxygen concentrator is compliant with all FAA requirements, guidelines, and other safety regulations applicable to respiratory assistive devices on aircraft. In particular embodiments, an airline might dedicate, by way of example, three seats in the front rows of every aircraft for oxygen-dependent passengers. These rows would be equipped with the present oxygen concentrator systems, along with sterile and disposable cannulas and any required additional tubing.

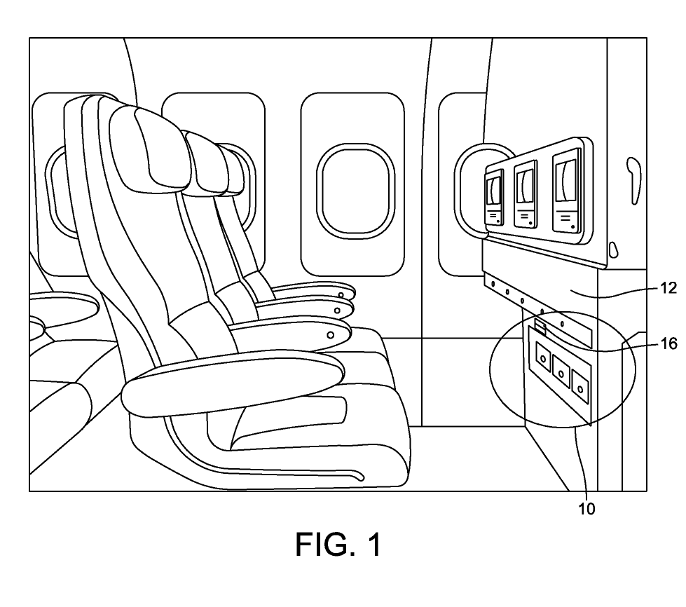

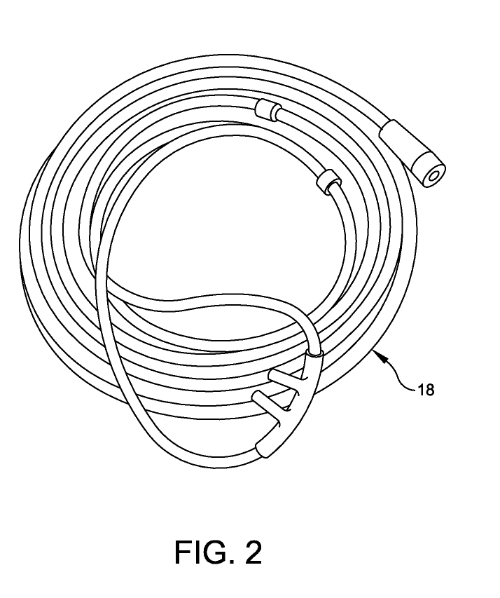

FIG. 1 provides an environmental view of an exemplary on-board oxygen concentrator 10 that is integrated into a bulkhead 12 of a commercial airliner, in accordance with one embodiment. Oxygen concentrator 10 may include a credit and/or debit card reader 16, or the like, or may be otherwise associated with a card reader. Card reader 16 may be used to accept payment for use of oxygen concentrator 10 and/or associated supplies such as a cannula or tubing 18, as shown in FIG. 2. Additionally and alternatively, card reader 16, in providing access to oxygen concentrator 10, may wirelessly confirm permission from the airline and/or a physician to use oxygen concentrator 10.

In addition or in alternative to card reader 16, an airline may include expenses associated with oxygen concentrator 10 in a passenger's ticket fare. This approach may provide the airline with a listing of oxygen-dependent passengers prior to the flight, allowing for proper seat assignments and associated accommodations. For instance, oxygen-dependent passengers might join wheelchair-dependent passengers as the first to board and/or exit the aircraft, in accordance with various embodiments. These passengers may also be provided an advance instruction manual or card (including, but not limited to, a pamphlet or a brochure) and traveling tips regarding their oxygen dependency and the benefits of the oxygen system.

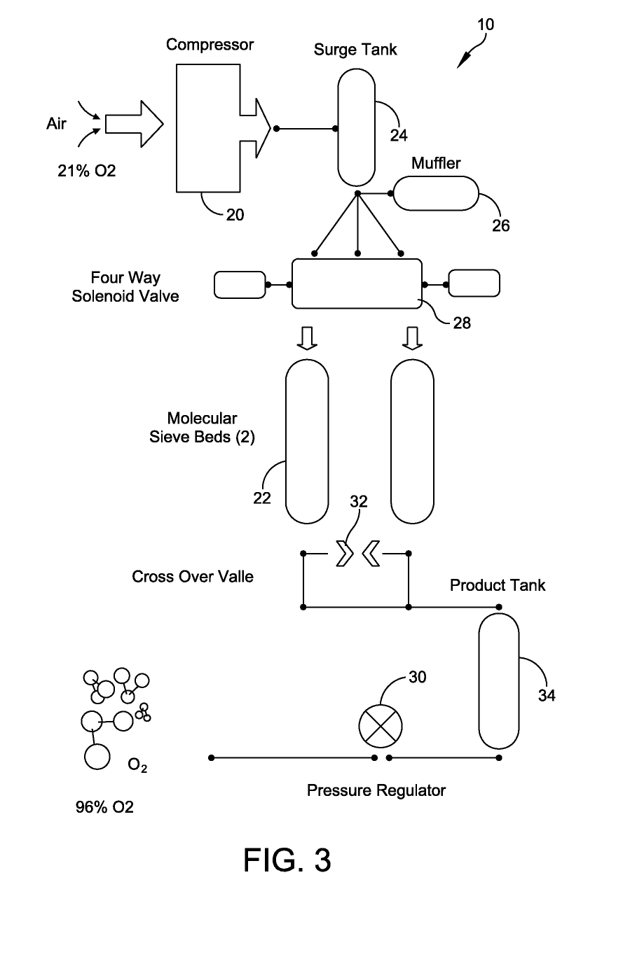

FIG. 3 diagrammatically illustrates one embodiment of oxygen concentrator 10. In this embodiment, oxygen concentrator 10 may include at least one air compressor 20 that is operatively connected to one or more zeolite, or microporous aluminosilicate granule, sieve beds 22. By way of a general overview, sieve beds 22 may receive compressed cabin air from compressor 20 and emit concentrated oxygen. In turn, an adjustable pressure regulator 30 controls the pressure of oxygen emitted to a passenger via tubing 18 (FIG. 2). These components may be secured within a compartment or bulkhead 12 of an aircraft as discussed in reference to FIG. 1, above, or they may be affixed within a seatback, seat bottom, or other similarly situated access point that allows for easy access by a seated passenger.

In greater detail, oxygen concentrator 10 may also include a surge tank 24, a muffler 26, a four-way solenoid valve 28, a cross-over valve 32, and a product tank 34. In accordance with various embodiments discussed herein, oxygen concentrator 10 generally operates in the following manner. Air at barometric pressure contains 21 % oxygen combined with nitrogen and other gases. Air is drawn into concentrator 10 by compressor or compressors 20 and routed through surge tank 24. Surge tank 24 may reside downstream from compressors 20 and act to absorb sudden pressure rises and/or provide extra airflow during brief drops in pressure.

From surge tank 24, compressed air may travel through four-way solenoid valve 28 or the like, exiting through the outlet ports of valve 28 into zeolite sieve beds 22, where the air undergoes a cycle of filtrations that results in purified oxygen. That is, the pressurized air passes through a series of chemical (e.g., zeolite) filters that disperse nitrogen and create concentrated oxygen. During this process, a portion of the produced oxygen may be conveyed to the patient via cross-over valve 32, product tank 34, and pressure regulator 30. A remaining portion of the produced oxygen may be drawn back into sieve beds 22 via cross-over valve 32 to further purify accumulated nitrogen. As a result, oxygen concentrator 10 has the capability of creating medical-grade oxygen of up to 96 % purity, continuously.

Adjustable pressure regulator 30 may control the outflow of produced oxygen depending on the oxygen-dependent patient's needs, typically measured in Liters Per Minute (LPM). The outflow is adjustable from one to five LPM. A simple handheld flow meter may be used to periodically check the flow rate to confirm a consistent output of produced oxygen.

In one embodiment, oxygen concentrator 10 may include a pulse setting, wherein oxygen is emitted only on the patient's inhalation. In this embodiment, oxygen flow stops as the patient exhales. In addition, oxygen concentrator 10 may optionally include a humidifier, which may take the form of a plastic bottle (not shown) connected to cannula or tubing 18 (FIG. 2). The plastic bottle may contain water that infuses into the produced oxygen for easy breathing and moisturizing of the passenger's nasal passages to prevent dryness.

When available in an aircraft, embodiments of oxygen concentrator 10 address the problem of having continuous oxygen on board passenger aircraft for oxygen-dependent passengers. Using oxygen concentrator 10 allows oxygen-dependent passengers the freedom of air travel without the risks and/or hassles associated with procuring, maintaining, and assuming responsibility for an FAA-approved portable oxygen concentrator.

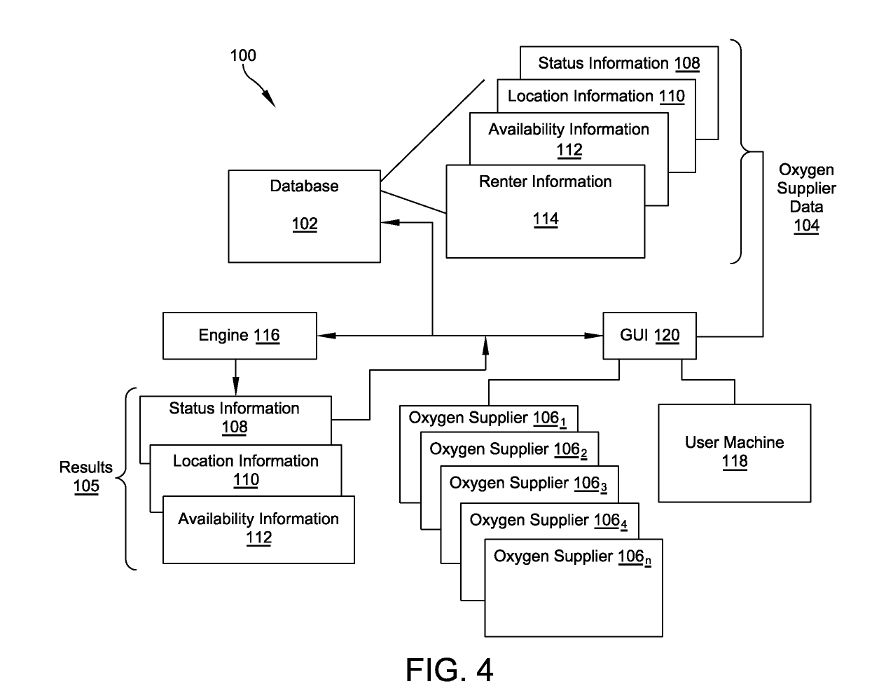

In accordance with another embodiment for providing oxygen to an oxygen-dependent airline passenger, a commercially available FAA approved oxygen concentrator may be provided to a passenger using an integrated system of kiosks or similar airport facilities at both the departure and arrival airports. In this embodiment, kiosks may be equipped with both FAA approved oxygen concentrators and other non-FAA approved oxygen suppliers, such as oxygen tanks and non-FAA approved oxygen concentrators. These devices may be associated with an embodiment of an oxygen reservation and tracking system 100, discussed below in reference to FIG. 4.

FIG. 4 shows a functional diagram of oxygen reservation and tracking system 100. System 100 provide a database 102 that receives and stores data 104 relating to a fleet of oxygen suppliers 106₁₋ₙ, which may include a variety of FAA approved and non-FAA approved devices. Data 104 may include status information 108 relating to each of oxygen suppliers 106₁₋ₙ, location information 110, availability information 112, renter information 114, and/or any other information necessary to efficiently operate system 100.

Database 102 may operate in communication with a processing engine 116 that provides logic for evaluating and analyzing data 104, discussed above, and orchestrating an efficient reservation-based rental system for oxygen suppliers 106₁₋ₙ. Engine 116 and database 102 may be resident on a user machine 118 or they may be accessible to user machine 118 via a network such as a local area network (LAN) or a wide area network (WAN) such as the Internet. User machine 118 may include, for example, a desktop computer, laptop computer, tablet, smartphone, or any other appropriate network-enabled device. Furthermore, engine 116 and database 102 may be resident on a single processing platform or a distributed processing architecture as appropriate.

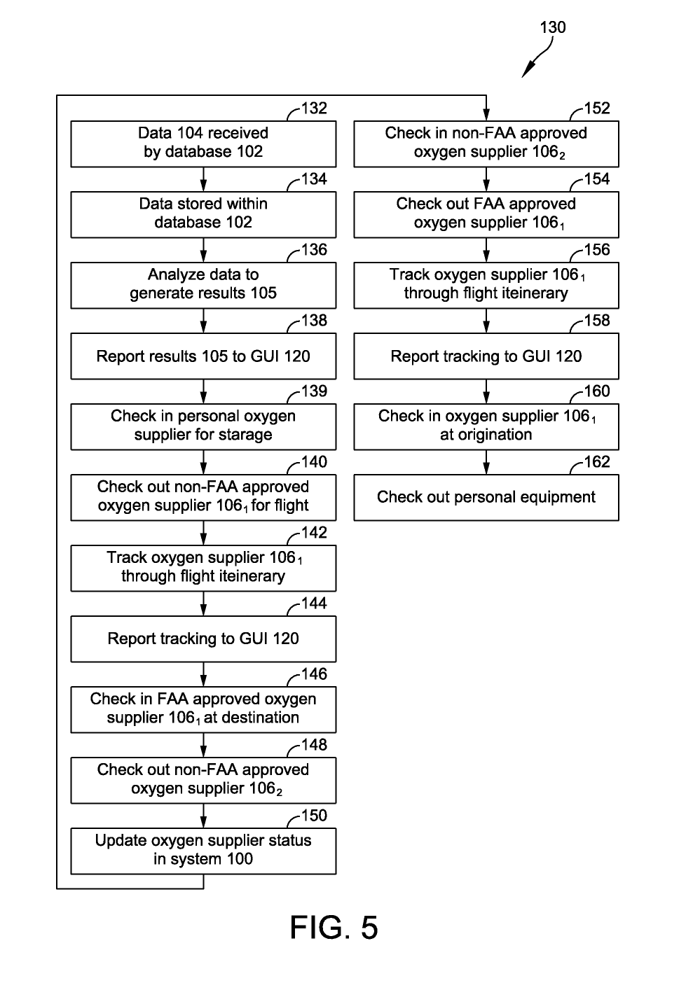

In this embodiment, system 100 may also include a graphical user interface (GUI) 120. GUI 120 may be incorporated within or made accessible to user machine 118 and may be incorporated within or made accessible to each of oxygen suppliers 106₁₋ₙ. Using GUI 120, a user may operate system 100 by inputting data 104 to database 102 and receiving results 105 from engine 116, as discussed below in reference to FIG. 5. In this regard, GUI 120 may be used for both data input and results retrieval.

FIG. 5 provides a flow chart detailing an exemplary process 130 for operating oxygen reservation and tracking system 100. For purposes of ease of explanation, process 130 will be described in relation to a single transaction, i.e., a single incident of air travel for an oxygen-dependent passenger.

In one embodiment, process 130 initiates when raw data 104 is input to and received by (132) database 102 using GUI 120. As discussed above, raw data 104 may include any appropriate information relating to the transaction, including but not limited to, renter information 114 (e.g., an oxygen-dependent passenger or other relevant renter's name, address, credit card information, flight itinerary, passenger needs, etc.) or any other information relevant to the passenger's inquiry. Once received, data 104 may be scrubbed, labeled, categorized, and stored (134) within database 102 in a manner ready for analysis.

After data receipt (132) and storage (134) are complete, engine 116 may analyze data 104 to generate (136) a number of results 105 and output (138) those results 105 to GUI 120. Results 105 may include any appropriate information relating to the reservation of oxygen suppliers 106₁₋ₙ, including a status, location, and/or availability of oxygen suppliers 106₁₋ₙ. For example, in response to an oxygen-dependent passenger's request, results 105 may include reservation information regarding drop-off and pick-up of one or more oxygen suppliers 106₁₋ₙ, as well as instructions regarding when, where, and how the passenger may retrieve and return the same.

Process 130 continues when the passenger arrives at his or her departure airport and, if applicable, checks in (139) his or her own non-FAA approved oxygen supplier for storage during the duration of the trip. Next, the passenger checks out (140) from the kiosk an FAA approved oxygen supplier 106₁ for his or her flight. System 100 may then track (142) oxygen supplier 106₁ and report (144) to GUI 120, which is associated with user machine 118 and/or oxygen supplier 106₁, regarding transit location, functionality, anticipated check in, or any other appropriate status and/or location information relevant to the transaction. For example, system 100 may report (144), based on itinerary and time records, that the rented FAA approved portable oxygen supplier 106₁ has reached its destination airport and provide instructions regarding a kiosk location within the destination airport where oxygen supplier 106₁ may be checked in. Alternatively, system 100 may provide an alert regarding an unacceptable delay in checking in FAA approved oxygen supplier 106₁, signifying a possible theft and/or penalty.

After landing at the destination airport, method 130 continues when the passenger checks in (146) FAA approved oxygen supplier 106₁. At the same time, and depending on the passenger's needs and his or her particular reservation, the passenger may check out (148) a non-FAA approved portable oxygen supplier 106₂, such as an air tank or a non-FAA approved portable oxygen concentrator, for use during his or her stay in the destination city. Upon this exchange, system 100 may update (150) the status of oxygen suppliers 106₁₋ₙ to reflect their current whereabouts and availability.

When the passenger returns to the airport for his or her return flight to the point of original departure, method 130 may essentially begin in reverse, this time with the passenger checking in (152) the rented non-FAA approved oxygen supplier 106₂ and checking out (154) another FAA approved oxygen supplier 106₁ for the return flight.

As discussed above, system 100 may track (156) oxygen supplier 106₁ and report (158) to GUI 120, which is associated with user machine 118 and/or oxygen supplier 106₁, regarding transit location, functionality, anticipated check in, and/or any other appropriate status or location information relevant to the transaction. Back at the original departure airport, or the home airport, the passenger may again check in (160) the rented FAA approved oxygen supplier 106₁ and check out (162) his or her own equipment that has been stored at the home kiosk. At each step of checking in and checking out along the passenger's journey, system 100 may receive data via GUI 120 regarding the transaction, record the transfer, and update database 102 accordingly.

Notably, data 104 may be received (132) from any appropriate party. While process 130, discussed above, relates to an oxygen-dependent passenger (i.e., a renter or prospective renter), in some instances data 104 may be provided by a representative of a DME company operating system 100. Such a representative might input availability information 112 (e.g., which oxygen suppliers 106₁₋ₙ are available at a certain kiosk location), location information 110 (e.g., a transit location of an oxygen supplier 106₁₋ₙ, check-in and check-out information), and/or status information 112 (e.g., an expected arrival time of any of oxygen suppliers 106₁₋ₙ) relating to oxygen suppliers 106₁₋ₙ, passengers, flights, airport issues, and more. Any user with access to GUI 120 may enter relevant data 104. Moreover, in some instances, status information 108, location information 110, availability information 112, and the like, may be entered as raw data 104. In other instances, the same information will be provided by engine 116 in the form of results 105. For example, an oxygen-dependent passenger may enter location information 108 in the form of flight itinerary details. On the flip side, engine 116 may provide location information 108 in the form of an anticipated location of an oxygen supplier 106₁₋ₙ based on the passenger's itinerary, the current time, and a known current flight status.

Using method 130, an oxygen-dependent passenger may be assured of constant access to oxygen throughout the duration of the passenger's trip, without breaks in oxygen supply between the passenger's origination (e.g., the passenger's residence) and destination. Depending upon a passenger's needs and personal equipment ownership, one or more of the steps of process 130 may be excluded. For instance, if the passenger's flight is equipped with an on-board oxygen concentrator 10, as discussed above in reference to FIGS. 1-3, that passenger may forego checking out (140) an FAA approved oxygen supplier 106₁ from the kiosk, and simply store his or her own equipment at the home kiosk and rent or check out (148) a non-FAA approved oxygen supplier 106₂ from the kiosk in the destination airport. Alternatively, a passenger may be planning to borrow a non-FAA approved oxygen supplier from a friend or relative in the destination city. In this example, the passenger would not have a need and therefore would not check out (148) or check back in (152) rented non-FAA approved oxygen supplier 106₂ for use in the destination city. Details regarding the passenger's needs may be provided at the time of reservation, or when renter information 114 is initially provided to and received by (132) database 102.

Additional embodiments address oxygen availability during a commute between the passenger's place of residence or other point of origination and the airport and vice versa, at both the departure and arrival/destination cities. More specifically, oxygen reservation and tracking system 100 may apply to another exemplary process 170 for providing oxygen to an oxygen-dependent aircraft passenger. In this embodiment, oxygen suppliers 106₁₋ₙ may include a variety of appropriate FAA or non-FAA approved devices supplied within associated commuter vehicles, non-FAA approved portable oxygen suppliers, FAA-approved portable oxygen suppliers, and stationary oxygen suppliers made available for use at boarding gates and other key points within the airport.

In one embodiment, process 170 initiates when raw data 104 is input to and received by (172) database 102 using GUI 120. In this embodiment, raw data 104 may include renter information 114, such as an oxygen-dependent passenger's name, address, flight itinerary, and a designated pick-up time for transfer to the departure airport. Once received, data 104 may be scrubbed, labeled, categorized, and stored (174) within database 102 in a manner ready for analysis.

After data receipt (172) and storage (174) are complete, engine 116 may analyze data 104 to generate (176) a number of results 105 and output (178) those results 105 to GUI 120, which is resident on or associated with user machine 118 and/or any one of oxygen suppliers 106₁₋ₙ. In this embodiment, results 105 may include any appropriate information relating to the transaction, including, for example, pick-up information, such as a reserved time and place, and/or the type of oxygen suppliers 106₁₋ₙ that have been reserved for the passenger's use throughout the duration of his or her trip.

Process 170 continues with an oxygen-assisted passenger pick-up (180) and transfer (182) to the departure airport. Any appropriate oxygen supplier 106₁₋ₙ may be made available during transit. At the departure airport, the passenger may be provided (184) with a non-FAA approved portable oxygen supplier 106₂ for the trip through check-in, security, and on to the boarding gate, where the passenger may be connected (186) to a stationary oxygen supplier 106₃, or a stationary oxygen concentrator. That is, at the boarding gate, a DME supply company representative may temporarily collect non-FAA approved portable oxygen supplier 106₂ from the passenger and connect the passenger to stationary oxygen concentrator 106₃, until the passenger is called to board the aircraft. As mentioned above, oxygen dependent passengers may be the first to board and exit the plane.

On-board oxygen access may be provided (188) by oxygen concentrator 10, discussed above in reference to FIGS. 1-3, or by a portable FAA approved oxygen supplier 106₁, provided by the DME company that is operating system 100.

At the destination/arrival airport, another DME supply company representative may meet the passenger at the arrival gate and provide a non-FAA approved portable oxygen supplier 106₂ (e.g., an oxygen tank) for an oxygen-assisted transfer (190) from the arrival gate to a commuter vehicle. The passenger may then use the same non-FAA approved portable oxygen supplier 106₂ or another appropriate device during his or her transfer (192) to a final destination. Process 170 may be repeated in its entirety when the passenger embarks on his or her return trip, thereby allowing an oxygen-dependent passenger to conveniently complete round-trip air travel without risk or hassle associated with independently owning an FAA approved oxygen concentrator.

In accordance with further embodiments and regardless off the presence of an in situ oxygen concentrator such as oxygen concentrator 10, discussed above, an FAA approved portable oxygen supplier 106₁, or an FAA approved portable oxygen concentrator, may be provided on board the aircraft at all times in case the oxygen-dependent passenger wishes to leave his or her seat, whether to use the restrooms or to walk about (such as to assist in avoiding thrombosis symptoms, or the like). In accordance with such embodiments, these FAA approved oxygen suppliers 106₁ may always be charged-up and ready for use. In accordance with such embodiments, a DME supply company may offer training for the flight attendants on how to operate the oxygen suppliers and on how to assist oxygen-dependent passengers with their respiratory needs.

The above-mentioned non-FAA approved portable oxygen suppliers, tanks and/or non-FAA approved oxygen concentrators may be covered by a patient's Medicare, Medicaid and/or insurance coverage, even if an FAA-approved oxygen concentrator is not.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. An on-board oxygen concentrator comprising:
at least one compressor secured in a compartment of an aircraft;
at least one zeolite sieve bed secured in a compartment of the aircraft and operatively connected to the at least one compressor to receive compressed aircraft cabin air from the compressor and emit concentrated oxygen; and
a pressure regulator to control pressure of emitted oxygen provided to a passenger of the aircraft.

2. The oxygen concentrator of claim 1, wherein the at least one compressor and the at least one zeolite sieve bed are secured in a same compartment of the aircraft.

3. The oxygen concentrator of claim 2, wherein the same compartment of the aircraft is a bulkhead of the aircraft.

4. The oxygen concentrator of claim 2, wherein the same compartment of the aircraft is a seatback of the aircraft.

5. A method of providing oxygen to an oxygen-dependent aircraft passenger using an oxygen reservation and tracking tool having a processing engine operatively coupled to a database and a graphical user interface, the method comprising:
receiving, via the graphical user interface, passenger information;
storing, by the database, the passenger information;
generating, by the processing engine, reservation information relating to one or more oxygen suppliers for use during a segmented journey involving a flight on an aircraft;
checking out, via the graphical user interface, a first of the oxygen suppliers for a first segment of the journey; and
checking out, via the graphical user interface, a second of the oxygen suppliers for a second segment of the journey.

6. The method of claim 5, wherein the one or more oxygen suppliers comprise a non-FAA approved portable oxygen concentrator, an oxygen tank, an FAA approved portable oxygen concentrator, a stationary oxygen supplier, and an on-board oxygen concentrator.

7. The method of claim 6, wherein the on-board oxygen concentrator comprises at least one compressor secured in a compartment of the aircraft, at least one zeolite sieve bed secured in the compartment of the aircraft and operatively connected to the at least one compressor to receive compressed aircraft cabin air from the compressor and emit concentrated oxygen, and a pressure regulator controlling pressure of emitted oxygen provided to the passenger while on board the aircraft.

8. The method of claim 6, wherein the stationary oxygen supplier is a stationary oxygen concentrator.

9. The method of claim 6, wherein the first oxygen supplier comprises the oxygen tank and the first segment of the journey comprises a drive between the passenger's residence and a departure airport.

10. The method of claim 9, wherein the second oxygen supplier comprises the stationary oxygen supplier and the second segment of the journey comprises a wait at the passenger's boarding gate.

11. The method of claim 10, further comprising checking out, via the graphical user interface, a third of the oxygen suppliers for a third segment of the journey.

12. The method of claim 11, wherein the third oxygen supplier comprises the on-board oxygen concentrator and the third segment of the journey comprises the flight on the aircraft.

13. The method of claim 5, wherein the checking out of the first oxygen supplier for the first segment of the journey comprises renting, from an airport kiosk at a departure airport, an FAA approved portable oxygen concentrator for the flight on the aircraft to an arrival airport.

14. The method of claim 13, wherein the checking out of the second oxygen supplier for the second segment of the journey comprises renting, from an airport kiosk at the arrival airport, a non-FAA approved portable oxygen supplier for a duration spent in an arrival location.

15. The method of claim 14, wherein the non-FAA approved portable oxygen supplier comprises one of a non-FAA approved portable oxygen concentrator and an oxygen tank.

16. The method of claim 15, further comprising:
exchanging, at the airport kiosk at the arrival airport, the second oxygen supplier for a third oxygen supplier for a third segment of the journey.

17. The method of claim 16, wherein the third oxygen supplier comprises another FAA approved portable oxygen concentrator and the third segment of the journey comprises a return flight to the departure airport.

18. A method of administering oxygen to an oxygen-dependent aircraft passenger, the method comprising:
administering oxygen, using a first oxygen supplier, over a first segment of a journey involving a flight on an aircraft;
exchanging the first oxygen supplier for a second oxygen supplier;
administering oxygen, using the second oxygen supplier, over a second segment of the journey involving the flight;
exchanging the second oxygen supplier for a third oxygen supplier; and
administering oxygen, using the third oxygen supplier, over a third segment of the journey involving the flight.

19. The method of claim 18, wherein the first oxygen supplier comprises a non-FAA approved portable oxygen supplier and the first segment comprises a drive between the passenger's residence and a departure airport.

20. The method of claim 19, wherein the non-FAA approved portable oxygen supplier comprises at least one oxygen tank.

21. The method of claim 19, wherein the second oxygen supplier comprises a stationary oxygen supplier and the second segment of the journey comprises a wait at the passenger's boarding gate.

22. The method of claim 19, wherein the third oxygen supplier comprises an on-board oxygen concentrator and the third segment of the journey comprises the flight on the aircraft.

23. The method of claim 22, wherein the on-board oxygen concentrator comprises at least one compressor secured in a compartment of the aircraft, at least one zeolite sieve bed secured in the compartment of the aircraft and operatively connected to the at least one compressor to receive compressed aircraft cabin air from the compressor and emit concentrated oxygen, and a pressure regulator controlling pressure of emitted oxygen provided to the passenger while on board the aircraft.

24. The method of claim 18, wherein the first oxygen supplier comprises an FAA-approved portable oxygen concentrator obtained from a kiosk in a departure airport and the first segment of the journey comprises the flight on the aircraft.

25. The method of claim 24, wherein the second oxygen supplier comprises a non-FAA approved portable oxygen concentrator obtained from a kiosk in an arrival airport and the second segment comprises a duration spent in an arrival location.
